(19) United States
(12) Patent Application Publication
(10) Pub. No.: US 2014/0019454 A1
(43) Pub. Date: Jan. 16, 2014

(54) Systems and Methods for Caching Data Object Identifiers

(71) Applicants: Jason A. Carter, Lehi, UT (US); David L. Cardon, Provo, UT (US)

(72) Inventors: Jason A. Carter, Lehi, UT (US); David L. Cardon, Provo, UT (US)

(21) Appl. No.: 13/545,765

(22) Filed: Jul. 10, 2012

(51) Int. Cl. G06F 17/30

(52) U.S. Cl. 707/741; 707/754; 707/752; 707/E17.059; 707/E17.083

(57) ABSTRACT

A server receives a query specifying filter criteria from a client. The server obtains the object identifiers (IDs) for the data objects satisfying the query from one or more object identifier caches. The data objects are retrieved from one or more data sources using lookups based on object identifiers (IDs) obtained from the one or more object identifier (ID) caches. The retrieved data objects are returned to the client in response to the query.

### BACKGROUND

Many businesses generate and store data for their business operations. In some instances businesses offer services to store and analyze the data for other businesses. For example, a business may store and analyze search engine marketing data. As another example, a retail business or financial business may store historical information for analysis. The data may be stored on multiple servers, computers or storage devices in multiple locations. In addition, the data may be broken into multiple components and stored in separate locations. For example, configuration data may be separate from historical data. Retrieving the data and stitching the data together can be time consuming due to the need to access multiple sources to locate the data, retrieve the data and stitch the data together. If the data is to be filtered in some manner, the more complex the criteria, the more computationally intensive the search for the data may be.

While computational processes can be fast, the sheer volume of data to process in addition to filter with complex criteria can cause requests for data to require long processing times (e.g., minutes or hours versus seconds). Thus, there is a need for identifying requested data and storing the information for faster subsequent lookup in response to requests.

### SUMMARY

Various embodiments of methods and systems are presented for caching at a server identifiers (IDs) of data objects retrieved from backend data sources in response to queries from clients. In some embodiments, a server receives a query from a client specifying filter criteria. The object identifiers (IDs) for data objects satisfying the query from one or more object identifier are obtained. The data objects from one or more data sources are retrieved and the object identifiers obtained are cached in an object identifier cache. The retrieved data objects are returned to the client in response to the query. If the same query is received again, the cached object IDs for that query can be used to quickly retrieve the data objects from the data sources by direct object ID (e.g., primary key) lookup.

In some embodiments, in response to receiving a query, the server determines whether an object identifier cache matching the query already exists. Determining whether an object identifier (ID) cache already exists may include calculating a query fingerprint identifier for the query based on the filter criteria specified in the query and determining whether any of the existing object identifier caches is indexed by a query fingerprint identifier matching the query fingerprint identifier for the query. In response to determining that an object identifier (ID) cache matching the query already exists, the object IDs are obtained from the existing object identifier cache matching the query.

If an object identifier cache matching the query does not exist, then the server performs a normal query of the data sources using the filter criteria for object identifiers for objects matching the filter criteria. The server caches in a new object identifier cache for the query the object identifiers received from a data source for objects matching the filter criteria.

### BRIEF DESCRIPTION OF THE DRAWINGS

FIG. 1 illustrates a system for retrieving data objects distributed across multiple backed data source, according to one embodiment.

FIG. 2 illustrates a flow diagram for an creating identifier (ID) cache of object IDs retrieved in response to a particular client query, according to one embodiment.

FIG. 3 is a flowchart of a method for an creating ID cache of object IDs in response to a particular client query, according to one embodiment.

FIG. 4 illustrates a flow diagram for determining object identifiers (IDs) using an existing ID cache in response to a client query, according to one embodiment.

FIG. 5 is a flowchart of a method for determining object IDs using an existing identifier (ID) cache in response to a client query, according to one embodiment.

FIG. 6 is a flowchart of a method for a server to retrieve data from one or more data sources in response to a client query, according to one embodiment.

FIG. 7 is a flowchart of a method for invalidating ID caches in a server, according to one embodiment.

FIG. 8 illustrates a flow diagram in a server accessing multiple ID caches corresponding to multiple data sources in response to a client query, according to one embodiment.

FIG. 9 is a flowchart of a method for a server to access multiple ID caches corresponding to multiple data sources in response to a client query, according to one embodiment.

FIG. 10 depicts the intersection of ID caches in an identifier (ID) cache joiner of a query server, according to one embodiment.

FIG. 11 is a flowchart of a method for retrieving a requested results page, according to one embodiment.

FIG. 12 is a flowchart of a method for retrieving data using traditional data source queries and ID caching in parallel, according to one embodiment.

FIG. 13 illustrates a computer system configured to implement a server configured with ID caching, according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Headings used herein are for organizational purposes only and are not meant to be used to limit the scope of the description.

### DETAILED DESCRIPTION OF EMBODIMENTS

As discussed in more detail below, embodiments provide systems and methods for caching of object identifiers at a server when responding to a client query. In some embodiments, a server receives a query from a client specifying filter criteria. The server may obtain object identifiers (IDs) for data objects satisfying the query from one or more object identifier caches. In some embodiments, the server retrieves data objects from one or more data sources using direct object ID lookups from one or more data sources using object identifiers obtained from the one or more object identifier caches. The server returns the retrieved data objects to the client in response to the query.

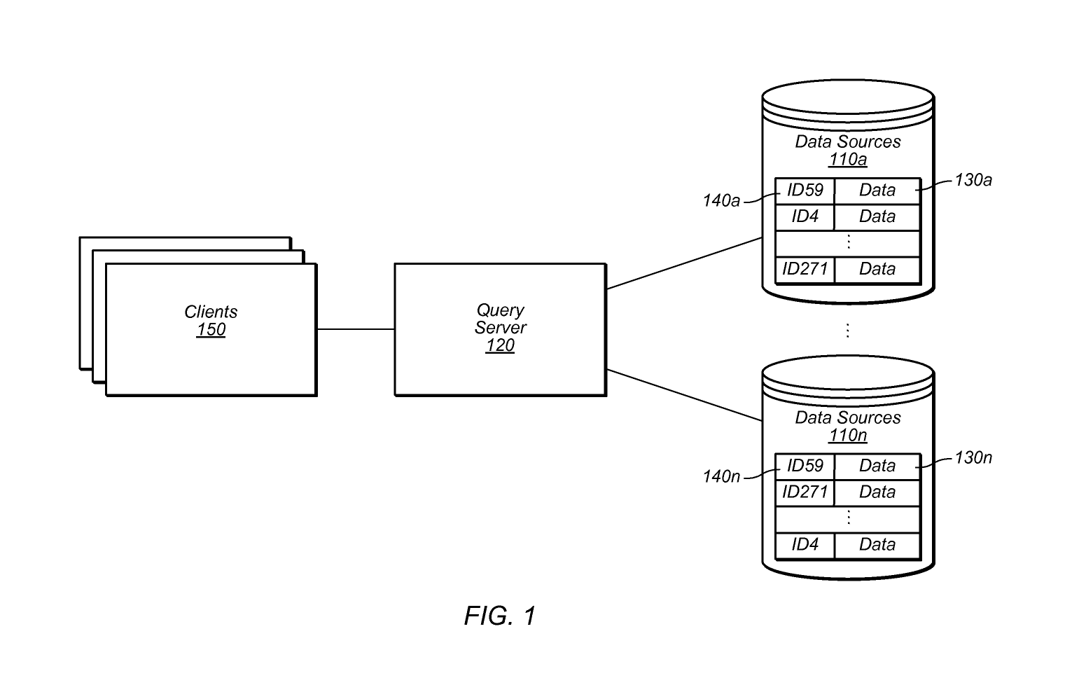

FIG. 1 illustrates a system from retrieving data objects from backend data source in response to client queries where the query server supports caching identifiers (IDs) of retrieved data objects, according to one embodiment. In general, a query server 120 receives requests for data stored in data sources 110 from clients 150. Data objects may be stored across multiple backend data sources 110. Each data object stored in data sources 110 have a corresponding object identifier (ID) 140. Different data values 130 for a particular data object may be stored in different data sources 130. For example, the data stored in data sources 110 may be data objects corresponding to search engine marketing (SEM) campaigns, in some embodiments. Each data object may be for a different keyword of a search engine marketing campaign. One data source 110 may store attribute data values for each data object, such as bid amount and number of impressions. Another data source may store data values representing the number of clicks for each data object, and a third data source may store values representing costs or conversions for each data object. Query server 120 may receive a query from a client 150. For example, a client 150 may include a SEM keyword management or reporting application, and the query may be a query to retrieve data to generate a report on the performance of a particular SEM campaign. The query may specify various filter criteria. In response to receiving filter criteria from a client 150, query server 120 accesses the one or more data sources 110 to determine the object IDs 140 of the data objects satisfying the filter criteria specified in the client's query.

In some embodiments, query server 120 includes one or more computers or servers 120. Query server 120 receives queries for data objects from clients 150. The queries may include filter criteria, for example. The filter criteria may specify values or ranges for various fields of the data objects, including dates and/or sort criteria. In response to receiving a query, query server 120 queries the one or more data sources 110 to determine which object IDs 140 include data 130 matching the filter criteria for that data source. Once query server 120 determines the corresponding object IDs 140 from each of the one or more data sources 110, query server 120 joins the results from each of the one or more data sources 110 to determine the final object IDs 140 that match the filter criteria. Query server 120 caches the object IDs and retrieves the data objects corresponding to the final object IDs 140 and returns the data objects to client 150.

In some embodiments, data sources 110 are one or more computers and/or storage devices configured as a database or data source server. Each data source 110 stores a part of the data 130 corresponding to a particular object ID 140. As discussed above, the data objects may correspond to keywords of search engine marketing campaigns, in some embodiments. For example, one data source may store transactional values for keywords on an SEM campaign managed by a SEM keyword management tool. Values set for various keywords, such as bid amounts, may be stored by the SEM keyword management tool in one data source 110. Data obtained from a search engine pertaining to the keywords of the SEM campaign may be stored in another one of data sources 110, and analytics data from a web analytics tool pertaining to the keywords of the SEM campaign may be stored in yet another one of data sources 110. In other embodiments, other types of data, such as financial transaction data, may be stored in data sources 110.

In one example, data sources 110 may store analytics data for network-based marketing campaigns. For example, a client 150 may send a query requesting data objects that satisfy a set of filter criteria. The filter criteria may be a range for a bid amount (e.g., $0.50<bid amount<$5.00), the number of impressions (e.g., impressions>0), the number of clicks (e.g., clicks<1000) and the cost (e.g., cost>$2.00). The data 130 corresponding to the search criteria is stored in multiple data sources. For example, the bid amount and the number of impressions may be stored in a first data source, the number of clicks in a second data source and the cost in a third data source. In response to receiving a query from a client 150, query server 120 determines the object ID 140 for the data in the data source matching the filter criteria. The query server 120 retrieves the data objects satisfying the filter criteria from data sources 110 and returns the data to the client. As explained in more detail below, query server 120 may employ data object ID caches to facilitate handling of client queries.

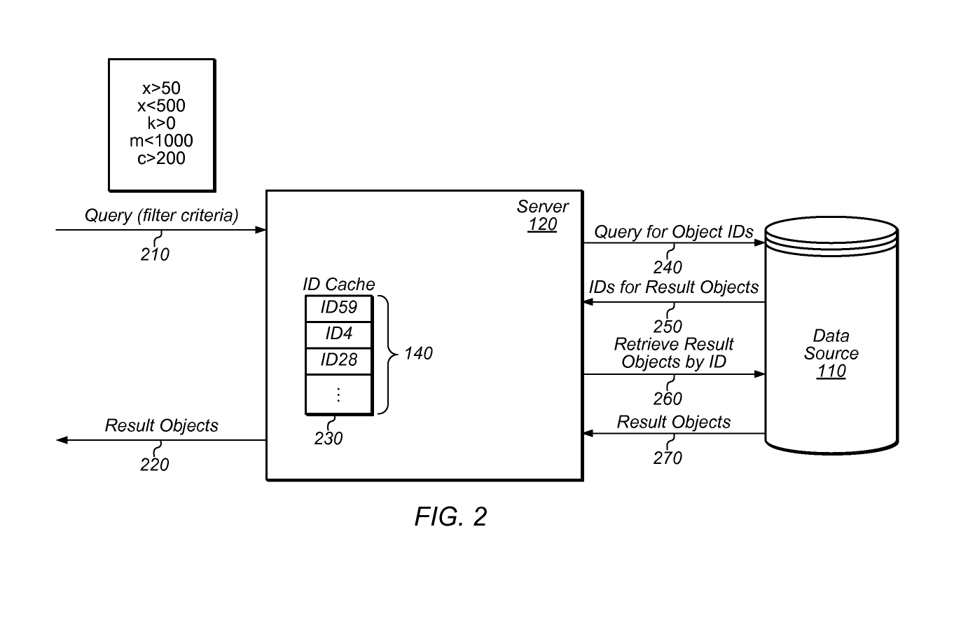

FIG. 2 illustrates a flow diagram for creating ID caches corresponding to object IDs retrieved in response to particular filter criteria, according to one embodiment. FIG. 2 illustrates a case where server 120 does not yet include an ID cache matching a particular received query, and consequently creates a corresponding ID cache as part of the process of responding to the query. The case illustrated in FIG. 2 is for a single data source for ease of illustration. In general, as described above, query server 120 receives from clients queries for data objects, where each query specifies one or more filter criteria. In response to receiving data query, query server 120 queries the data source 110 to determine the object IDs of the data objects having data that matches the filter criteria. The query server uses the object IDs to retrieve the data objects from data source 110. Server 120 stores the object IDs in an ID cache. In response to receiving the same filter criteria in a subsequent query, server 120 can now use the object IDs from the object ID cache to directly retrieve the data objects from data source 110 to satisfy the query without having to query the data source 110 using the filter criteria. This will be discussed in more detail below.

For example, query server 120 may receive a query (including filter criteria) from a client, as indicated at 210. As an example, data source 110 may store analytics data for network-based marketing campaigns. A client may request data based on four search criteria. The search criteria may be a range for a bid amount (e.g., $0.50<bid amount<$5.00), the number of impressions (e.g., impressions>0), the number of clicks (e.g., clicks<1000) and the cost (e.g., cost>$2.00). As shown in FIG. 2 for this example, x in the filter criteria represents bid amount, k represents impressions, m represents clicks, and c represents cost.

As shown at 240, since an ID cache corresponding to the query does not currently exist at server 120, in response to receiving the query, query server 120 uses the filter criteria to query data source 110 for object IDs of data objects having data matching the filter criteria of the query. Query server 120 receives the IDs (e.g., object IDs 140) for result objects, as shown at 250. The IDs for the results objects are stored in an ID cache 230. Just the object IDs are cached, not the corresponding data objects themselves. A given ID cache 230 is created specific to the filter criteria of the query. In response to subsequent queries for the same filter criteria, the ID cache 230 corresponding to the filter criteria can be located to determine the object IDs 140 instead of query server 120 having to query data source 110 using the filter criteria. This will be described in further detail below. Query server 120 retrieves results objects from data source 110 using the object IDs to directly request the objects from data source 110 (e.g., as a primary key lookup), as indicated at 260. Result objects received at server 120 from data source 110, as indicated at 270, and then returned to the client as indicated at 220.

The example described above shows query server 120 using the filter criteria to first query data source 100 for the IDs of objects matching the filter criteria, then using the object IDs to retrieve the actual data objects from data source 110. In other embodiments, query server 120 may query data source 110 for both the object IDs and data objects as part of the same operation. In addition, although the filter criteria example shown in FIG. 2 has four criteria (e.g., variables), any number of criteria and/or ranges can be used. Filter criteria can be any number of variables describing data for the query server 120 to locate. For simplicity, a single data source is shown, but as described above, multiple data sources are configured to store components of data corresponding to an object ID (e.g. object ID 140 in FIGS. 1 and 2).

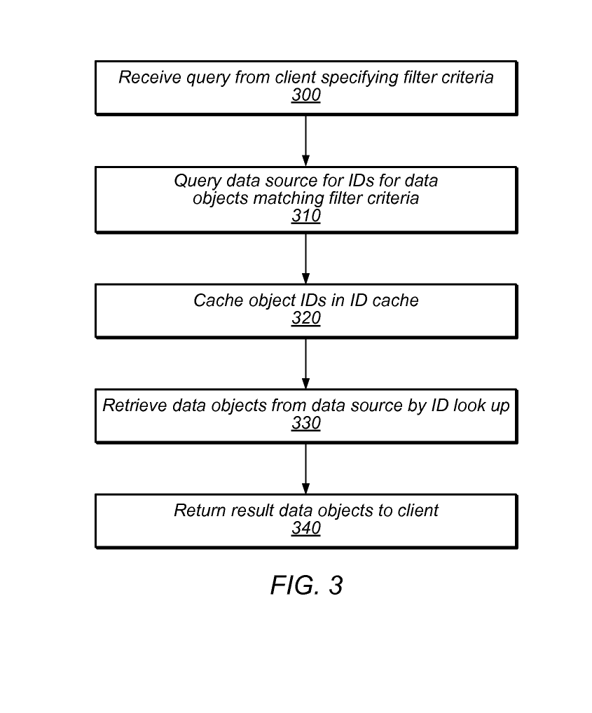

FIG. 3 is a flowchart of a method for creating identifier (ID) caches corresponding to object IDs in response to particular search criteria, according to one embodiment. As discussed above, queries specifying filter criteria (e.g., filter criteria 210 in FIG. 2) are received from clients (e.g., clients 150 in FIG. 1). As discussed above, filter criteria may include one or more variables with ranges, limits or values. In response to receiving the filter criteria, one or more data sources are queried for IDs of data objects (e.g., object IDs 140 in FIG. 1) matching the filter criteria. The resulting object IDs are cached in an ID cache (e.g., ID cache 230 in FIG. 2). Subsequent searches or queries with the same filter criteria will have the object IDs determined through the ID cache instead of querying the data source (e.g., data sources 110 in FIG. 1) based on the filter criteria. The data objects may be retrieved by object ID (e.g., object ID 140 in FIG. 2) from the data source and returned to the client.

As indicated in 300, in some embodiments, a query specifying filter criteria is received from the client. The filter criteria (e.g., filter criteria 210 in FIG. 2) may be one or more variables or criteria used to determine data stored in a data source. The criteria may indicate a range for a particular variable (e.g., 50<x<500). The criteria may indicate a limit (e.g., k>0, m<1000). One or more of the criteria can be a sort criteria, in some embodiments. For example, a limit may be set for a given filter criteria (e.g., c>200) and a sort (e.g., in increasing value) based on that same criteria.

Assuming the server does not already have an ID cache corresponding to the filter criteria, as indicated in 310, the data source is queried for IDs (e.g., object IDs 140 in FIG. 2) for data objects matching the filter criteria. As discussed above, data objects are stored in one or more data sources (e.g., data sources 110 in FIG. 1). Each data object has a corresponding object ID (e.g., object ID 140 in FIG. 1). The object ID for each data object having data that matches the filter criteria is obtained from the data source(s), but the data objects themselves are not necessarily retrieved at this point.

As indicated in 320, object IDs are cached in an ID cache. The object IDs determined at 310 are stored in an ID cache (e.g., ID cache 230 in FIG. 2). The ID cache is indexed to the particular query (e.g., based on the filter criteria of the query) that initiated the data source query.

As indicated in 330, data objects are retrieved from the data source by ID look up. The data objects corresponding to the object IDs (e.g., object ID 140 in FIG. 2), determined as indicated in 310 above, are retrieved by query server 120 from the data source (e.g., data source 110 in FIG. 2) by object ID look up. As indicated in 340, the data objects located via the object ID lookup are return to the client (e.g., client 150 in FIG. 1) to respond to the client's query.

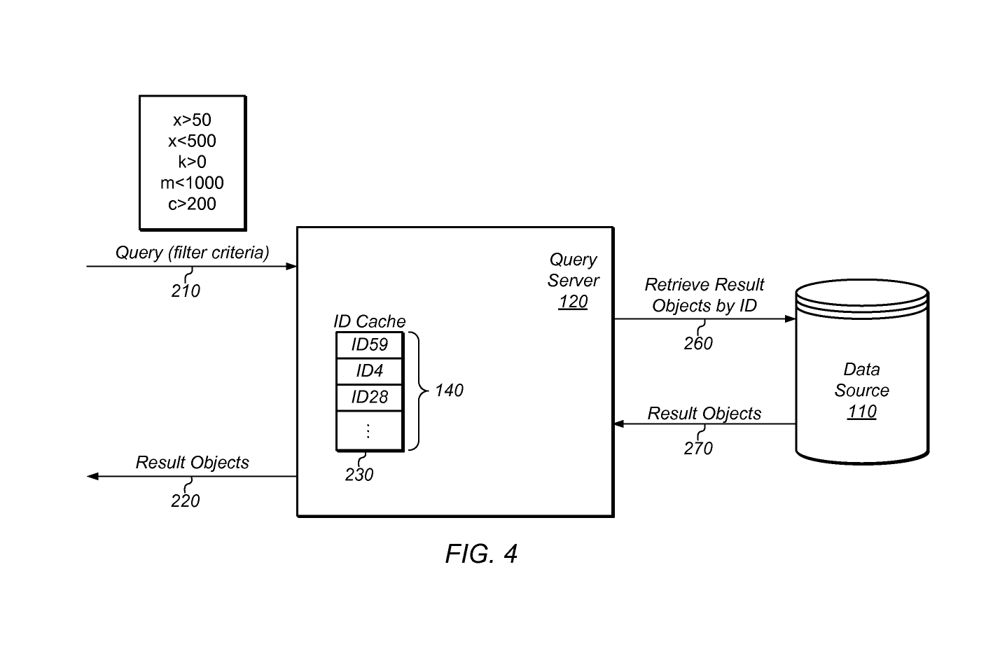

FIG. 4 illustrates a flow diagram, for determining object IDs using an existing ID cache, according to one embodiment. In general, if an ID cache 230 already exists in query server 120, the object IDs (e.g. object IDs 140 in FIGS. 1 and 2) are already determined for the corresponding filter criteria (e.g., filter criteria 210 in FIGS. 1 and 2). In response to receiving the same filter criteria, query server 120 looks up the ID cache (e.g., ID cache 230 in FIG. 2) to determine the object IDs (e.g. object IDs 140 in FIG. 2). Query server 240 looks up data objects in the data source (e.g., data source 110 in FIG. 1) by object IDs (e.g., object IDs in FIG. 2) and returns the resulting data to the client.

In some embodiments, as discussed above, query server 120 receives queries (e.g., filter criteria) 210 from clients (e.g., clients 150 in FIG. 1). If a query specifying the same filter criteria 210 has been previously received, an ID cache 230 corresponding to the filter criteria 210 may exist in query server 120. The existing ID cache 230 stores the object IDs 140 identifying the data objects in data source 110 that satisfy the filter criteria 210. With an existing ID cache 230, query server can determine the object IDs 230 for the objects satisfying the filter criteria without having to query data source 110 using the filter criteria. Thus, query server 120 can retrieve result objects by ID lookup from data source 110, as indicated at 260. Query server 120 obtains the result objects from data source 110 for the object IDs from ID cache 230, as indicated at 270, and may then return the results objects to the client (e.g., client 150 in FIG. 1) in response to the client's query, as indicated at 220.

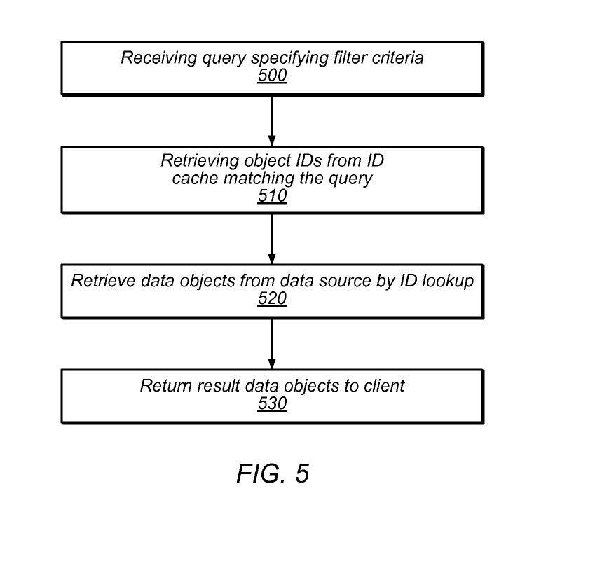

FIG. 5 is a flowchart of a method for determining object IDs using existing ID caches, according to one embodiment. As discussed above, queries (e.g., query 210 in FIG. 4) specifying filter criteria are received (e.g., from clients 150 in FIG. 1). As described above, the queries may have one or more variables with ranges or limits. If a particular query has already been received, then an ID cache (e.g., ID cache 230 in FIG. 4) may exist for that query in query server 120. A given ID cache stores the object IDs (e.g., object IDs 140 in FIG. 4) corresponding to the data objects that match a particular set of filter criteria (e.g., filter criteria 210 in FIG. 4). With the existing ID cache, a query server (e.g., query server 120 in FIG. 4) need only to look up the object ID to retrieve the data. Without the existing ID cache, the data sources would need to be queried according to the filter criteria to determine the data objects having data matching the filter criteria. Thus, with the existing ID cache, data objects satisfying the filter criteria may be retrieved more rapidly using a direct retrieval by object ID from the data source(s).

As indicated in 500, in some embodiments, a query specifying filter criteria is received. As discussed above, filter criteria is one or more variables. The variables may be a range (e.g., 50<x<500), or a limit (e.g., K>0), or have sort criteria (e.g., sort in increasing values).

As indicated in 510, in some embodiments, assuming an ID cache already exists in the server for the specified filter criteria, object IDs are retrieved from the ID cache matching the query. If the query has been previously received, the ID cache corresponding to the query (e.g., filter criteria) may exist. The object IDs (e.g., object ID 140 in FIG. 4) are retrieved from the ID cache.

As indicated in 520, in some embodiments, data objects are retrieved from the data source by ID lookup. The object IDs determined as indicated in 510 above are used (e.g., by query server 120 in FIG. 4) to look up data objects in a data source (e.g., data source 110 in FIG. 4) and retrieve the data objects. As indicated in 530, in some embodiments, the resulting data objects are returned (e.g., by query server 120 in FIG. 4) to the client (e.g., client 150 in FIG. 1).

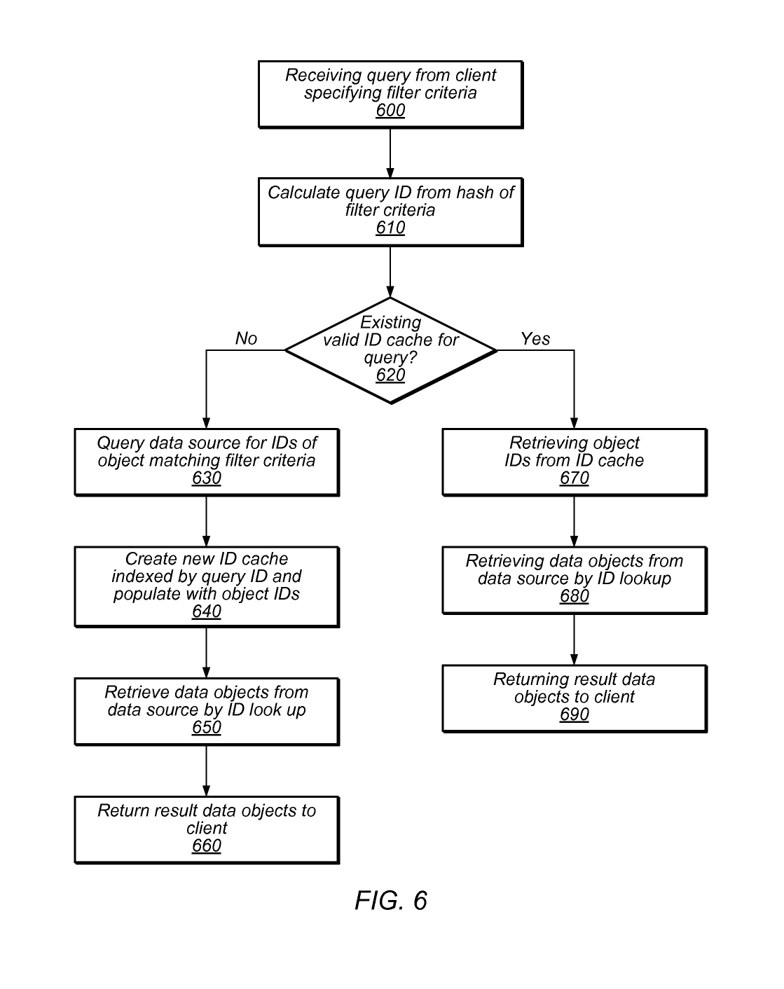

FIG. 6 is a flowchart of a method for a server to retrieve data from one or more data sources in response to a client query, according to one embodiment. FIG. illustrates how the server may determine whether or not an ID cache for a particular query already exists at the server, according to one embodiment. In response to receiving a query specifying filter criteria (e.g. filter criteria 210 in FIG. 2) from a client (e.g., client 150 in FIG. 1), a query server (e.g., query server 120 in FIG. 1) determines an identifier for the query, (i.e., a query ID). For example, the query ID may be generated using a hash or another function to create a fingerprint of the filter criteria of the query. Based on the query ID, the query server determines if there is an existing, valid ID cache (e.g. ID cache 230 in FIG. 4). If there is an existing, valid ID cache, then the object IDs from the ID cache are retrieved. The query server looks up the data objects in the one or more data sources (e.g., data source 110 in FIG. 4) to retrieve the data objects. The data objects are returned to the client. If there is not an existing valid ID cache, then the data source is queried to determine the IDs for data objects matching the filter criteria. The resulting object IDs (e.g., object IDs 140 in FIG. 4) are used to populate a new ID cache. The ID cache is indexed or identified by the query ID determined from the hash of the filter criteria. As discussed above, other functions to create a fingerprint of the filter criteria may also be used. The data objects (e.g., data 130 in FIG. 1) are retrieved (e.g., by query server 120 in FIG. 4) by ID look up (e.g., by object ID in FIG. 1) and returned to the client.

As indicated in 600, in some embodiments, a query specifying filter criteria is received from the client. As discussed above, the filter criteria (e.g., filter criteria 210 in FIG. 2) may be one or more variables or criteria used to determine data stored in a data source. The criteria may indicate a range for a particular variable (e.g., 50<x<500). The criteria may indicate a limit (e.g. K>0, M<1000). One or more of the criteria can be a sort criteria, in some embodiments. For example, a limit may be set for a given filter criteria (e.g., C>200) and a sort in increasing value specified based on the same variable.

As indicated in 610, in some embodiments, the query ID is calculated from a hash of the filter criteria. The filter criteria may be hashed or have some other function applied to create a unique (or statistically unlikely to be repeated) fingerprint of the query. The hash or fingerprint of the filter criteria forms the query ID. The query ID is used to identify an existing ID cache or to index a new ID cache.

In some embodiments, if there is not an existing valid ID cache for a query, as indicated in 620, the data source is queried for IDs of objects matching filter criteria, as indicated in 630, in some embodiments. As discussed above in FIG. 1, each of the one or more data sources stores data objects identified by an object ID (e.g., object ID 140 in FIG. 1). As discussed above each of the one or more data sources may store portions of the data (e.g., data 130 in FIG. 1) identified by an object ID.

As indicated in 640, in some embodiments, a new ID cache (e.g. ID cache 230 in FIG. 4) indexed by the query ID is created and populated with the object IDs (e.g., object ID 140 in FIG. 4) satisfying the filter criteria. The new ID cache is identified or indexed by the calculated query ID (e.g., calculated from the filter criteria as indicated in 610). The new ID cache is available for subsequent queries with the same filter criteria. This will be described in further detail below.

As indicated in 650, the data objects are retrieved from the data source by object ID lookup. As discussed above, the data objects are stored in one or more data sources and identified by object ID (e.g., object ID 140 in FIG. 4). The object IDs are used (e.g., by query server 120 in FIG. 4) to look up the data and retrieve the data. As indicated, the result data objects are returned to the client (e.g., client 150 in FIG. 1).

In some embodiments, if there is an existing valid ID cache for a query, as indicated in 620, the object IDs are retrieved from the ID cache, as indicated in 670. As discussed above, if a query (e.g. filter criteria 210 in FIG. 4) matches a query requested by a client in a prior query, an ID cache (e.g., ID cache 130 in FIG. 4) populated with the object IDs (e.g., object IDs 140 in FIG. 4) satisfying that query may already exists. The ID cache is determined by creating a query ID from the filter criteria and looking up the ID cache by query ID. The object IDs are retrieved from the ID cache corresponding to the query ID.

As indicated in 680, in some embodiments, the data objects are retrieved from the data source by ID lookup (e.g., by primary key access). The retrieved object IDs, as indicated in 670, determine the data objects to be retrieved from one or more data sources (e.g., data sources 110 in FIG. 4). The retrieved data objects are returned to the client (e.g., client 150 in FIG. 1) as indicated in 690, in some embodiments.

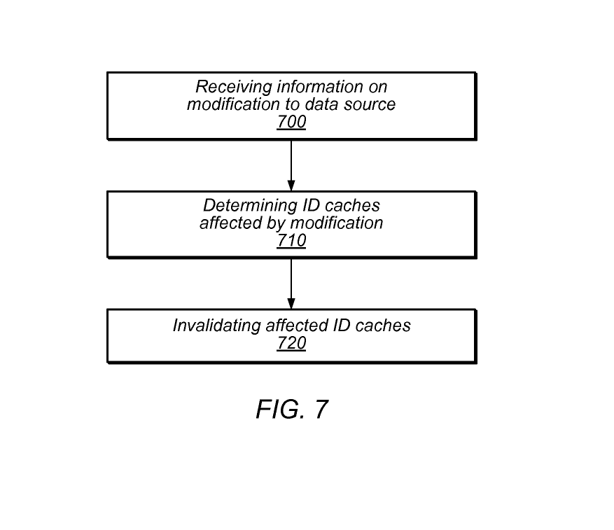

FIG. 7 is a flowchart of a method for invalidating ID caches in a server, according to one embodiment. As discussed above, an ID cache (e.g., ID cache 230) is identified by a query ID that is a hash or unique fingerprint of the filter criteria used to determine the object IDs populating the ID cache. However, in some embodiments, new data values for a data object with a given object ID may be stored in a data source (e.g., data source 110 in FIG. 1). Modification of data values in the data source invalidates the object IDs (e.g., object ID 140 in FIG. 1) corresponding to the filter criteria of the ID cache populated with the object IDs. In some embodiments, information is received indicating a modification of one or more data objects in the data source. Also, another form of modification may be addition of new data objects that may result in one or more ID caches becoming stale. The ID caches affected by the modification are determined and the affected ID caches are invalidated.

As indicated in 700, in some embodiments, information corresponding to modification of a data source is received. In some embodiments, a data source (e.g., data sources 110 in FIG. 1) may indicate the change to a query server (e.g., query server 120 in FIG. 1). In alternate embodiments, a query server may monitor the data source to determine data modifications in the data source. In alternate embodiments, a server and/or other computing device implementing the modification in the data source may send information to the query server (e.g., query server 120 in FIG. 4) indicating the change. In some embodiments, information such as the object ID (e.g., object ID 140 in FIG. 1) are received with the indication that the data source has been modified.

As indicated in 710, in some embodiments, ID caches affected by the modification are determined. In response to receiving the indication that one or more data sources have been modified, a query server (e.g., query server 120 in FIG. 4) determines the ID caches affected by the modification. As discussed above, data objects stored in data sources (e.g., data sources 110 in FIG. 2) are identified by object ID. The data objects that have been modified will have a corresponding object ID (e.g., object ID 140 in FIG. 1). A query server (e.g., query server 120 in FIG. 1) receives the object IDs and can search the ID caches to determine the ID caches affected by the modified data values. In other embodiments, the query server may store the data object fields used as filter criteria for each ID cache. In such embodiments, when the query server learns of a modification to a certain field for a set of data objects in a data source, all query caches for which that field was a filter criteria will be invalidated. Such an embodiment may provide a faster validation process at the expense of potentially invalidating more ID caches than necessary.

As indicated in 720, in some embodiments, the affected ID caches (e.g., ID caches 230 in FIG. 4) are invalidated. In some embodiments, the affected ID caches may be tagged as invalid. In alternate embodiments, the affected ID caches may be deleted or over written.

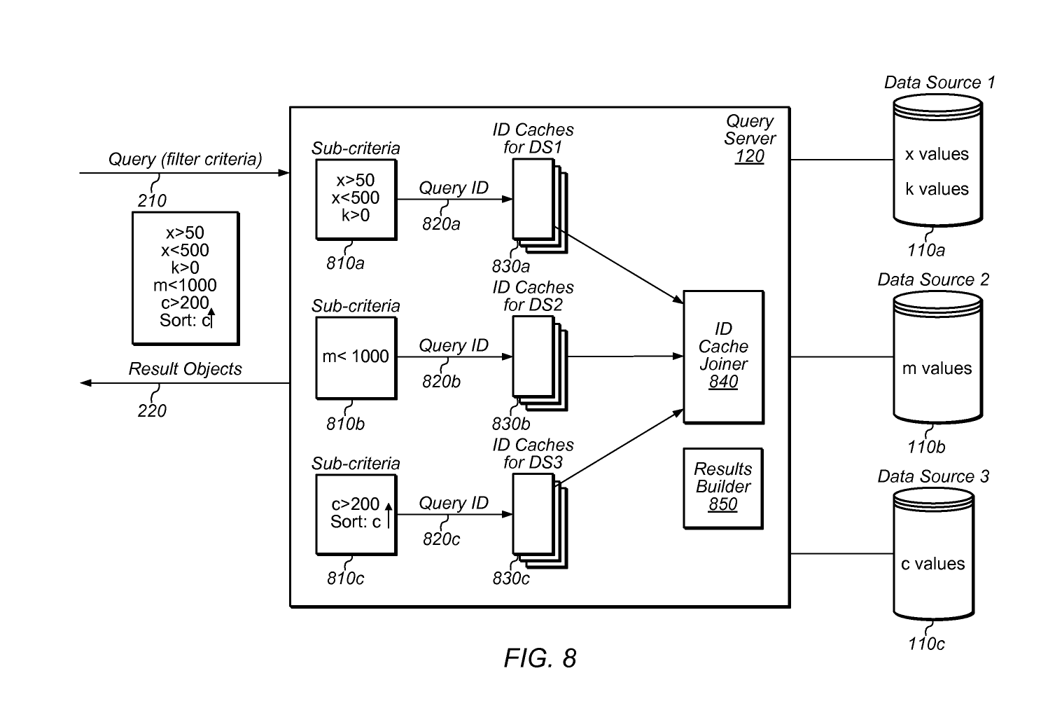

FIG. 8 illustrates flow diagram in a server accessing multiple ID caches corresponding to multiple data sources in response to filter criteria, according to one embodiment. In general, as described above, query server 120 receives a query 210 (e.g., filter criteria from a client (e.g., client 150 in FIG. 1)). The filter criteria may be one or more variables with limits, ranges or sort criteria. The data that filter criteria matches is stored on one or more data sources 110. Query server 120 segments filter criteria 210 into sub-criteria 810 according to the data source 110 that stores the data. Server 120 maintains a set of ID caches 830 for each data source 110. An ID cache 830 is identified by a hash or other unique fingerprint of the respective sub-criteria 810 and populated with object IDs (e.g., object ID 140 in FIG. 1) representing the data corresponding to sub-criteria 810. Once the ID cache corresponding to the respective sub-criteria 810 is determined, an ID cache joiner 840 determines the intersection of the ID caches 830 for a particular query 210. The object IDs that the ID caches have in common are used by results builder 850 to look up the data objects in data sources 110 and build the results. The results are returned to the client.

In some embodiments, query server 120 receives queries (e.g., filter criteria) 210 from clients (e.g., clients 150 in FIG. 1). Filter criteria may include one or more variables with ranges (e.g., 50<x<500), limits (e.g., k>0) and/or sort criteria (e.g., c>200 sort in increasing value). Query server 120 segments filter criteria 210 into sub-criteria 810 according to the data source 110 storing the data for that sub-criteria 810. For example, sub-criteria 810a includes x and k sub-criteria. Query server 120 segments the data in this manner since the x and k values are stored in data source 1 (110a). Sub-criteria 810b includes only the m criteria since data source 2 (110b) stores the m values corresponding to the m sub-criteria. Sub-criteria 810c includes the c sub-criteria and a sort criteria of sorting by c in increasing value. The sort criteria is enforced in ID cache joiner 840 and results builder 850. This will be described in more detail below.

Sub-criteria query ID 820, in some embodiments, identifies or indexes an ID cache 830 populated with the object IDs (e.g., object IDs 140 in FIG. 1) of the data in the data sources 110 matching the sub-criteria 810. Sub-criteria query ID 820 is determined by hashing or otherwise fingerprinting the sub-criteria 810. Sub-criteria query ID 820 is the identifier or index for locating and existing ID cache 830. As described above if ID cache 830 does not exist, query ID 820 can be used to index a new ID cache 830.

ID cache 830, in some embodiments, stores object IDs (e.g., object IDs 140 in FIG. 1). The object IDs identify data stored in data source 110 that matches sub-criteria 810. Populating ID cache 830 with the object IDs allows query server to determine matches to sub-criteria 810 without query data sources 110 using the sub-criteria 810.

ID cache joiner 840, in some embodiments, determines the intersection of the object IDs populated in ID caches 830 identified by query ID 820. As discussed above, query ID 820 is calculated from sub-criteria 810. The object IDs in common between ID caches 830a, 830b and 830c identified by query ID 820a, 820b and 820c determine the object IDs that results builder 850 use to look up data in data sources 110. The common object IDs (e.g., object IDs 140 in FIG. 4) as determined by ID cache joiner 840 identify the data in data sources 110 matching filter criteria 210. ID cache joiner 840 also enforces the sort criteria corresponding to sub-criteria 810c. The common object IDs will be sorted in the order of sort criteria 810c (e.g., C>200 in increasing value), in this example.

Results builder 850, in some embodiments, retrieves the data from data objects sources 110 by object ID lookup. Results builder 850 receives the common object IDs as determined by the intersection of the ID caches matching sub-criteria 810. Results builder retrieves data via object ID lookup in data sources 110. Results builder 850 combines the retrieved data. The results are returned the client (e.g., results objects 220).

Data sources 110, in some embodiments, are databases or other systems (e.g., servers) configured to store data. The data sources may exist in a distributed system, in some embodiments. The data objects stored in data sources have different portions of their data stored in each data source 110. For example, a particular data source (e.g., data source 1, 110a) may store configuration data. As another example, a particular data source (e.g., data source 2, 110b) may store historical performance data or custom assignments.

As an example, data sources 110 may store transactional and analytics data for network-based marketing campaigns. A client may request data based on four search criteria. The search criteria may be a range for a bid amount (e.g., $0.50<bid amount<$5.00), the number of impressions (e.g., impressions>0), the number of clicks (e.g., clicks<1000) and the cost (e.g., cost>$2.00). The data 130 corresponding to the search criteria is stored in multiple data sources. For example, the bid amount and the number of impressions may be stored in a first data source (e.g., data source 1, 110a), the number of clicks in a second data source (e.g., data source 2, 110b) and the cost in a third data source (e.g., data source 3, 110c). In response to receiving a query from a client 150, query server 120 calculates a respective query ID for each sub-criteria and determines that the ID cache (e.g. ID cache 830) exists for each sub-criteria (e.g. sub-criteria 810). An ID cache joiner (e.g., ID cache joiner 840) receives the object IDs from the ID caches (e.g., ID caches 830) and performs the intersection of the object IDs for each respective ID cache. The common object IDs determined from the intersection of the object IDs from each respective ID cache are used by a results builder (e.g., results builder 850) to look up the data in the respective data source (e.g., data sources 110). The data is combined and returned to the client.

Query server 120 queries the ID cache 230 for the object IDs 140 for the data in the data source matching the filter criteria. Query server 120 retrieves the data from data source 110 via object ID lookup. However, all of the object IDs corresponding to two of the search criteria may not fit the four search criteria. To determine the object IDs that match all four of the search criteria, the results of the query for the first data source is joined with the second and third data source query results. The query server queries the second data source to determine the object IDs for the data corresponding to the number of clicks criteria. The query server queries the third data source to determine the object IDs corresponding to the cost search criteria. However, as discussed above, the query results from the second and third data sources may not match the search criteria. The query server joins (e.g., intersects) the results from each of the respective data sources to determine the object IDs that match the search criteria described above. The query server uses the joined object ID results to retrieve the data objects from the data sources to present to the client.

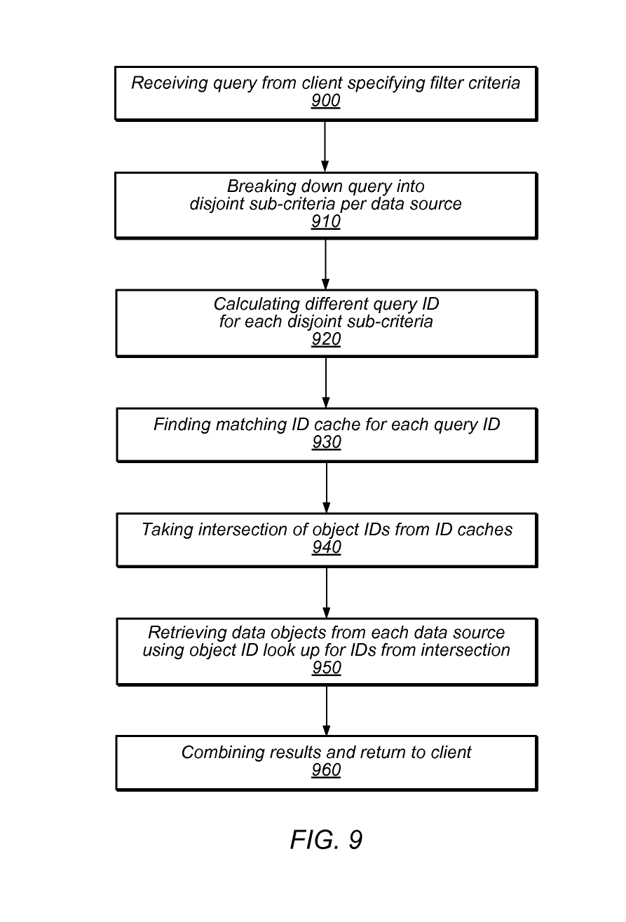

FIG. 9 is a flowchart of a method for a server to access multiple ID caches corresponding to multiple data sources in response to filter criteria, according to one embodiment. As discussed above, queries specifying filter criteria are received (e.g., by query server 120 in FIG. 8) from clients (e.g., clients 150 in FIG. 1). The queries are broken down into disjoint sub-criteria (e.g., sub-criteria 810 in FIG. 8) according to where the data is stored. For example, sub-criteria 810a in FIG. 8 includes x and k filter criteria. The filter criteria is segmented into the x and k grouping since data source 1 (110a) stores the data for x and k. A query ID (e.g., query ID in FIG. 8) is calculated with the sub-criteria (e.g., sub-criteria 810 in FIG. 8). The query ID is an index or identifier for looking up ID caches. As described above, each ID cache (e.g. ID caches 830 in FIG. 8) is populated with object IDs corresponding to sub-criteria that formed the ID cache. Each sub-criteria (e.g., sub-criteria 810 in FIG. 8) corresponds to a respective ID cache (e.g., ID cache 830 in FIG. 8) which corresponds to a data source (e.g., data sources 110 in FIG. 8). The intersection of the ID caches identified by the sub-criteria and query ID are intersected to determine a common set of object IDs (e.g., in ID cache joiner 840 in FIG. 8). The common set of object IDs are used (e.g., by a results builder 850 in FIG. 8) to look up the data stored in the data sources (e.g., data sources 110 in FIG. 8). The data from each data source, as determined by the object ID lookup, is combined into results and returned to the client (e.g., results objects 220 in FIG. 8).

As indicated in 900, in some embodiments, a query is received from a client specifying filter criteria. As discussed above, the queries or filter criteria (e.g., filter criteria 210 in FIG. 2) may be one or more variables or criteria used to determine data stored in a data source. The criteria may indicate a range for a particular variable (e.g., 50<x<500). The criteria may indicate a limit (e.g. k>0, m<1000). One or more of the criteria can be a sort criteria, in some embodiments. For example, a limit may be set for a given filter criteria (e.g., c>200) and a sort specified by that same criteria, for example, in increasing value. This constraint will affect the order of other data corresponding to the filter criteria.

As indicated in 910, in some embodiments, the query is broken down into disjoint sub-criteria per data source. For example, if a given data source stores criteria x and k (e.g., data source 1 (110a) in FIG. 8), then criteria x and k will be grouped together in sub-criteria (e.g., sub-criteria 810a in FIG. 8)

As indicated in 920, in some embodiments, the query ID for each disjoint sub-criteria is calculated. As discussed above, a query ID (e.g., query ID 820 in FIG. 8) is determined by calculating a hash or via another function configured to create a unique fingerprint. The calculated query ID is used to index a new ID cache (e.g., ID cache 830) or, as indicated in 930, in some embodiments, the matching ID cache for each query ID is found.

As indicated in 940, in some embodiments, the intersection of object IDs from the ID caches is determined. As discussed above, ID caches exist for each sub-criteria. Once ID caches matching the sub-criteria are determined, as indicated in 930 above, the intersection of the ID caches is determined (e.g., ID cache joiner 840 in FIG. 8). The common object IDs found by the intersection of the ID caches are used to look up (e.g., by results builder 850) data objects in data sources (e.g., data sources 110 in FIG. 8)

As indicated in 950, in some embodiments, data objects are retrieved from each data source using object ID look up for object IDs from the intersection of ID caches. As described above, the common object IDs determined in 940 above, are used to look up data in the data sources and retrieve the data objects from each data source.

As indicated in 960, in some embodiments, the results are combined and returned to the client. As described above, components of each data object are stored in one or more data sources (e.g., data sources 110 in FIG. 8). As the data from each data source is retrieved via object ID lookup, the data associated with a specific object ID is combined and the results returned to the client (e.g., result objects 220 in FIG. 8).

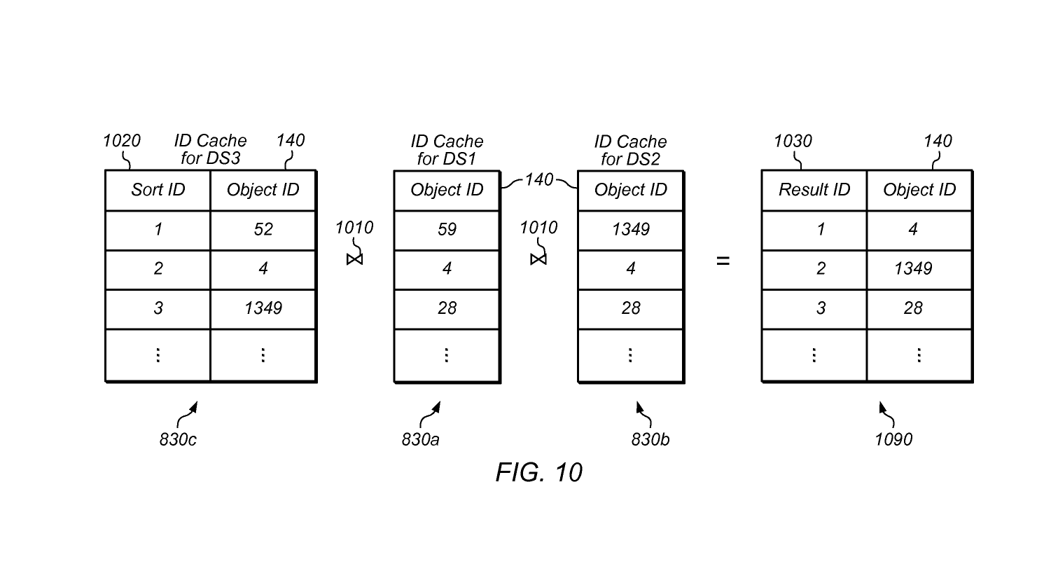

FIG. 10 depicts the intersection of ID caches in an ID cache joiner of a query server, according to one embodiment. In general as described above, server 120 maintains a respective set of ID caches (e.g., ID caches 830 in FIG. 8) for each data source (e.g., data sources 110 in FIG. 8), wherein each ID cache is indexed by a respective sub-criteria query ID (e.g., query IDs 820 in FIG. 8). As described above, once ID caches have been identified for a particular query, an ID cache joiner (e.g., ID cache joiner 840 in FIG. 8) determines the intersection of the intersection of the ID caches to determine a common set of object IDs. In addition, as described above, sort criteria may be specified for one or more filter criteria. This constrains the order of the results of the intersection also. This will be described in more detail below.

For example, an ID cache 830c has one or more object IDs 140 as determined by the sub-criteria (e.g., sub-criteria 810c in FIG. 8) that matches data in a data source 3 (e.g., data source 3 110c in FIG. 8). Since a sort was specified for the sub-criteria, the object IDs are ordered according to the sort criteria and ID cache 830c has a sort ID 1020 that determines the order of the object IDs. When ID cache 830c is intersected (as indicated by join operator 1010) with ID cache 830a for data source 1 (e.g., data source 1 (110a) in FIG. 8) and ID cache 830b for data source 2 (e.g., data source 2 (110a) in FIG. 8), the sort order is preserved. This will be described in more detail below.

Table 1090 depicts the sorted intersection of the three ID caches. Object ID 4, object ID 1349, object ID 28 and so on were common in the three ID caches and are ordered according to the order of ID cache 830c on the left-hand side since ID cache 830c corresponds to the sub-criteria for which the sort was specified. Results ID 1030 indicates the sorted order of the results 1090. For example, in the ID cache 830c for data source 3, the order is object ID 52, object ID 4, object ID 1349, and so on. Object ID 52 is dropped since object ID 52 doesn't have a common object ID in ID cache 830a or 830b. However, object ID 4 and object 1349 also populate ID caches 830a and 830b. In results table 1090, object ID 4 and object ID 1349 populate table 1090 in the order of sort ID 1020.

Result ID 1030 not only preserves the sort ID order from ID cache 830c, but provides for fast paging through results. For example, table 1090 may have one thousand Results ID/Object ID pairs entered in the table but only the first twenty-five are returned to the client as a first page of results. The client (e.g., client 150 in FIG. 1) can request a next page of results and the server (e.g., query server 12 in FIG. 8) can locate the range of results ID for the requested page via the results ID 1030.

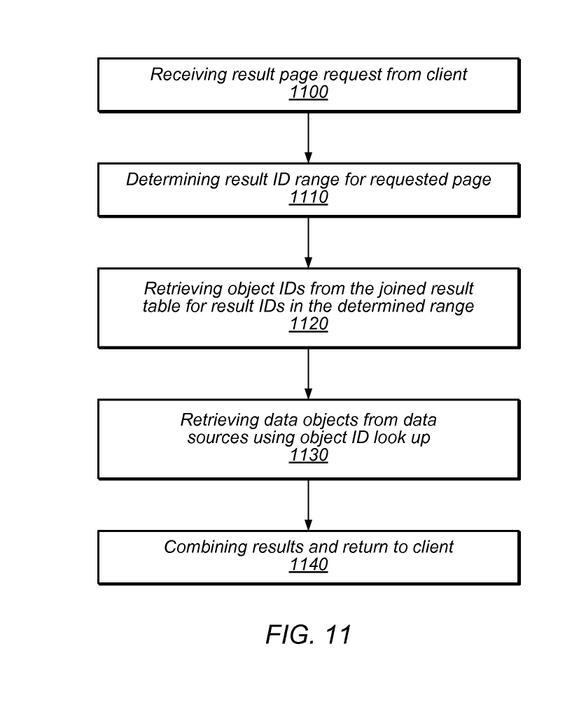

FIG. 11 is a flowchart of a method for retrieving a requested results page, according to one embodiment. As described above, the results (e.g. table 1090 of FIG. 10) are determined from the intersection of the ID caches (e.g. ID caches 830 in FIG. 10). The ID caches are populated with the object IDs (e.g., object IDs 140 in FIG. 10) for the data in the data sources (e.g., data sources 110 in FIG. 8) that match the filter criteria (e.g., filter criteria 210 in FIG. 8). The results (e.g., table 1090 in FIG. 10) have a result ID (e.g., result ID 1030 in FIG. 10) that a query server (e.g., query server 120 in FIG. 8) uses to page through the results. For example, the results may have one thousand object IDs (e.g., object IDs 140 in FIG. 10) but only twenty five results are displayed at a time at client 150. The client may request a particular page of the results. The query server (e.g., query server 120 in FIG. 8) determines the results ID (e.g., results ID 1030 in FIG. 10) corresponding to the requested page of the results and returns the results to the client (e.g., client 150 in FIG. 1). To return the results to the client, a results builder (e.g., results builder 850 in FIG. 8) looks up the object ID (e.g., object IDs in FIG. 10) in the data sources (e.g., data sources 110 in FIG. 8) and retrieves the data objects. The data is combined (e.g., in results builder 850 in FIG. 8) and returned to the client for the requested page.

As indicated in 1100, in some embodiments, a results page request is received from the client. The requested page may be a next page, or a particular numbered page of results.

As indicated in 1110, in some embodiments, a results ID range for a requested page is determined. In response to receiving a page request from a client (e.g., client 150 in FIG. 1), the results ID range corresponding to requested page is determined (e.g., by results builder 850 in FIG. 8). The results IDs, as described above, are stored in a results table (e.g., results table 1090 in FIG. 10) for each object ID (e.g., object ID 140 in FIG. 10).

As indicated in 1120, object IDs from the joined result table are retrieved for the results IDs in the determined range. As discussed above, the object IDs (e.g., object ID 140 in FIG. 10) are used to look up data objects in the data sources (e.g., by results builder 850 in FIG. 8).

As indicated in 1130, data objects are retrieved from data sources using object ID look up. With the object IDs (e.g., object ID 140 in FIG. 10) determined above, the data can by located by object ID lookup in the data sources. The data can be retrieved and as indicated in 1140, the results are combined and returned to the client (e.g., by results builder 850 in FIG. 8).

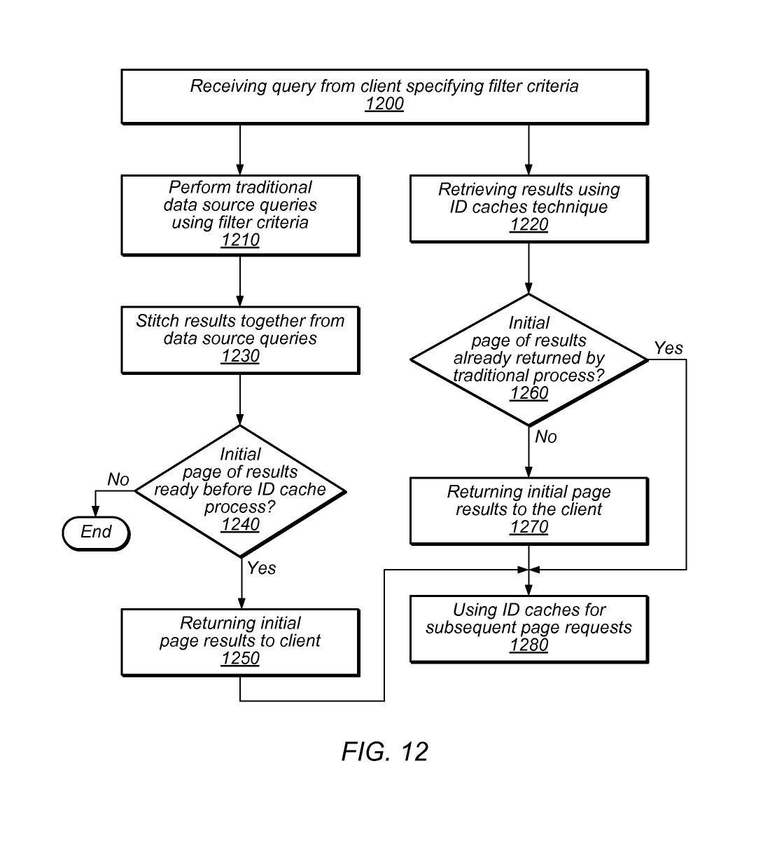

FIG. 12 is a flowchart of a method for retrieving data objects using traditional data source queries and ID caching in parallel, according to one embodiment. As discussed above, ID caches (e.g., ID caches 830 in FIG. 2) are created to store object IDs (e.g., object IDs 140 in FIG. 2) of data in data sources (e.g., data sources 110 in FIG. 2). In response to receiving filter criteria (e.g., filter criteria 210 in FIG. 2), the results can be retrieved via the ID cache technique described above. Simultaneously, the data sources may be queried in a traditional manner for data objects matching the filter criteria and the results of the traditional queries may be stitched together. Results for an initial page are returned to the client using whichever technique obtains the result objects for the initial page first. If the client requests to view another page of the results, the ID cache method, as described above in FIG. 11, is used to retrieve the results corresponding to the requested page. The traditional method of retrieval of data from data sources is performed in parallel to the ID cache method described above. In response to receiving the query from the client specifying filter criteria, the filter criteria are used to query the data sources (e.g., data sources 110 in FIG. 1). The data retrieved from the data sources is stitched together and if the stitched data is ready before the result determined by the ID cache method, the initial page results are returned to the client. In some cases, an initial page of results may be retrieved faster using the traditional method, for example, if query caches for the query do not already exist. If query caches for the query do not already exist, then the query cache technique may first build the query caches for the complete result set, and then retrieve the data objects for the first page of results. In such a case, the traditional method may return the first page of result objects first. For subsequent pages, the query cache technique would typically be used since the query caches would typically be complete by the time a subsequent result page was requested.

As indicated in 1200, a query specifying filter criteria is received from a client. As discussed above, the filter criteria (e.g., filter criteria 210 in FIG. 2) is one or more criteria specified with ranges, limits or sort criteria. The filter criteria determines the data retrieved from the data sources (e.g., data sources 110 in FIG. 1). In some embodiments, a traditional data source query is performed with the received filter criteria in parallel to the ID cache method above. Depending on the complexity of the filter criteria and whether matching ID caches are already present, one method can be faster than the other method, at least for an initial set of results.

As indicated in 1220, the results for the filter criteria received from the client are retrieved using the ID cache technique. As discussed above, the ID caches technique creates and stores ID caches for filter criteria received from the client. The filter criteria is used to determine the query IDs for the caches and determine to object IDs for the data corresponding to the filter criteria in the data sources. The object IDs populate the ID caches and are used to look up data in the data sources when subsequent matching queries are received.

As indicated in 1260, if the initial page of results has not already been returned via the traditional method, then the initial page results are returned to the client, as indicated in 1270. Subsequent page requests use the ID caches technique, as indicated in 1280. As described above in FIG. 11, the result ID range for the requested page is determined and the corresponding object ID are used to lookup data in the data sources. The data from the data sources is combined and returned to the client.

As indicated in 1260, in some embodiments, if the initial page of results has already been returned via the traditional method, then the initial page of results from the ID caches technique are not returned. As indicated in 1280 (as described above), in some embodiments, subsequent page requests use the ID caches technique.

As indicated in 1210, traditional data source queries using the filter criteria are performed in parallel with ID caches technique at 1220. In response to receiving the query specifying filter criteria from the client, the filter criteria is used to locate the data objects in the data sources and retrieve the data objects from the data sources.

As indicated in 1230, the results are stitched together from the data source queries. As discussed above, one or more data sources store components of data from data objects. The data is retrieved from the multiple data sources and stitched together into results including only data objects satisfying all the filter criteria.

As indicated in 1240, in some embodiments, if the initial page of results is not ready before the results of the ID cache process described above, then the method ends at 1240 and subsequent data retrieves are performed as described at 1280. If the initial page of results is ready before the ID cache process, then the initial page of result is returned to the client, as indicated in 1250. The ID caches technique, as described above, is used for subsequent page requests, however.

### Example Computer System

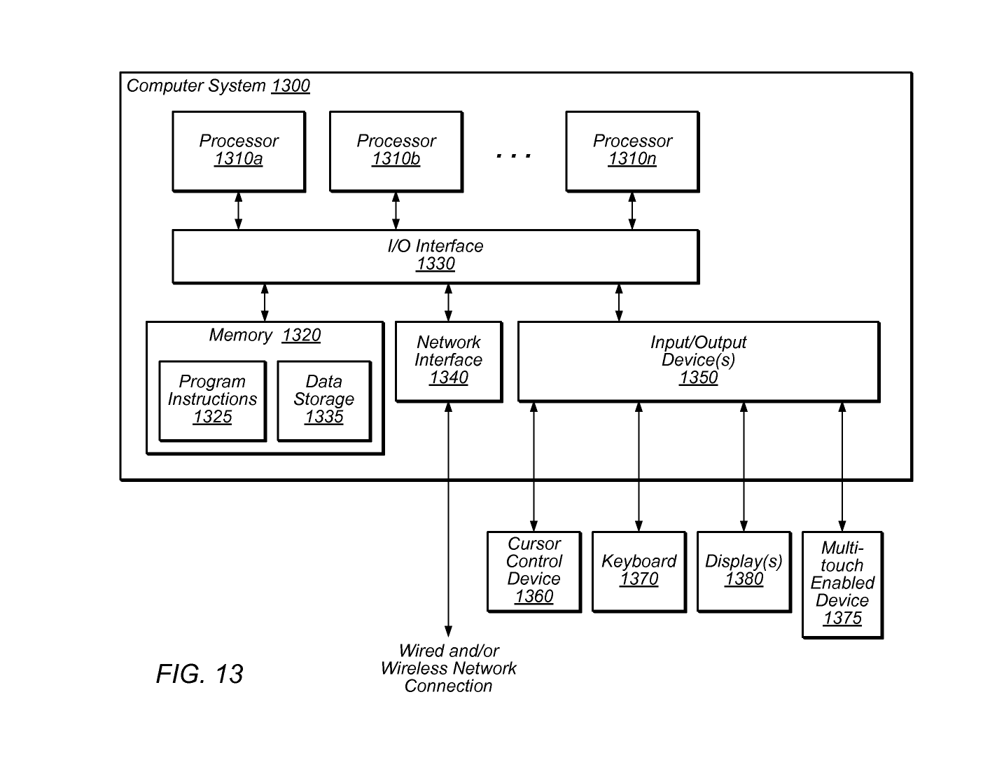

FIG. 13 illustrates a computer system configured to implement a server configured with ID caching, according to one embodiment. Various portions of systems in FIGS. 1, 2, 4, and 8 methods presented in FIGS. 3, 6-7, 9, and 11-12 and/or described herein, may be executed on one or more computer systems similar to that described herein, which may interact with various other devices of the system. For example, ID cache joiner 840, results builder 850 and/or creation of ID cache 230 may be executed on a processor in a computing device.

In the illustrated embodiment, computer system 1300 includes one or more processors 1310 coupled to a system memory 1320 via an input/output (I/O) interface 1330. Computer system 1300 further includes a network interface 1340 coupled to I/O interface 1330, and one or more input/output devices 1350, such as cursor control device 1360, keyboard 1370, audio device 1390, and display(s) 1380. In some embodiments, it is contemplated that embodiments may be implemented using a single instance of computer system 1300, while in other embodiments multiple such systems, or multiple nodes making up computer system 1300, may be configured to host different portions or instances of embodiments. For example, in one embodiment some elements may be implemented via one or more nodes of computer system 1300 that are distinct from those nodes implementing other elements.

In various embodiments, computer system 1300 may be a uniprocessor system including one processor 1310, or a multiprocessor system including several processors 1310 (e.g., two, four, eight, or another suitable number). Processors 1310 may be any suitable processor capable of executing instructions. For example, in various embodiments, processors 1310 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA.

System memory 1320 may be configured to store program instructions and/or data accessible by processor 1310. In various embodiments, system memory 1320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a load balancing of time-based tasks in a distributed computing method, are shown stored within system memory 1320 as program instructions 1325 and data storage 1335, respectively. In other embodiments, program instructions and/or data may be received, sent or stored upon different types of computer-accessible media or on similar media separate from system memory 1320 or computer system 1300. Generally speaking, a computer-accessible medium may include storage media or memory media such as magnetic or optical media, e.g., disk or CD/DVD-ROM coupled to computer system 1300 via I/O interface 1330. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1340. Program instructions may include instructions for implementing the techniques described with respect to FIGS. 1-12.

In some embodiments, I/O interface 1330 may be configured to coordinate I/O traffic between processor 1310, system memory 1320, and any peripheral devices in the device, including network interface 1340 or other peripheral interfaces, such as input/output devices 1350. In some embodiments, I/O interface 1330 may perform any necessary protocol, timing or other data transformations to convert data signals from one component (e.g., system memory 1320) into a format suitable for use by another component (e.g., processor 1310). In some embodiments, I/O interface 1330 may include support for devices attached through various types of peripheral buses, such as a variant of the Peripheral Component Interconnect (PCI) bus standard or the Universal Serial Bus (USB) standard, for example. In some embodiments, the function of I/O interface 1330 may be split into two or more separate components. In addition, in some embodiments some or all of the functionality of I/O interface 1330, such as an interface to system memory 1320, may be incorporated directly into processor 1310.

Network interface 1340 may be configured to allow data to be exchanged between computer system 1300 and other devices attached to a network, such as other computer systems, or between nodes of computer system 1300. In various embodiments, network interface 1340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1350 may, in some embodiments, include one or more display terminals, keyboards, keypads, touchpads, scanning devices, voice or optical recognition devices, multi-touch screens, or any other devices suitable for entering or retrieving data by one or more computer system 1300. Multiple input/output devices 1350 may be present in computer system 1300 or may be distributed on various nodes of computer system 1300. In some embodiments, similar input/output devices may be separate from computer system 1300 and may interact with one or more nodes of computer system 1300 through a wired or wireless connection, such as over network interface 1340.

Memory 1320 may include program instructions 1325, configured to implement embodiments of a load balancing of time-based tasks in a distributed computing method as described herein, and data storage 1335, comprising various data accessible by program instructions 1325. In one embodiment, program instructions 1325 may include software elements of a method illustrated in the above Figures. Data storage 1335 may include data that may be used in embodiments described herein. In other embodiments, other or different software elements and/or data may be included.

Those skilled in the art will appreciate that computer system 1300 is merely illustrative and is not intended to limit the scope of a load balancing of time-based tasks in a distributed computing method and system as described herein. In particular, the computer system and devices may include any combination of hardware or software that can perform the indicated functions, including computers, network devices, internet appliances, PDAs, wireless phones, pagers, etc. Computer system 1300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1300 may be transmitted to computer system 1300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations. In some embodiments, portions of the techniques described herein may be hosted in a cloud computing or distributed computing infrastructure.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Various modifications and changes may be to the above technique made as would be obvious to a person skilled in the art having the benefit of this disclosure. It is intended that the invention embrace all such modifications and changes and, accordingly, the above description to be regarded in an illustrative rather than a restrictive sense. While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Any headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

1. A method, comprising:
performing, by a server:
receiving a query from a client specifying a filter criteria;
obtaining, by a processor, object identifiers for data objects satisfying the query from one or more object identifier caches, wherein an object identifier cache of the one or more object identifier caches is specific to the filter criteria, the object identifier cache having object identifiers corresponding to querying using only the filter criteria;
retrieving data objects from one or more data sources using lookup based on object identifiers obtained from the one or more object identifier caches; and
returning the retrieved data objects to the client in response to the query.

2. The method of claim 1, further comprising, in response to said receiving the query, determining whether an object identifier cache specific to a query identifier for the query already exists.

3. The method of claim 2, further comprising, in response to determining that the object identifier cache specific to the query identifier already exists, performing said obtaining from the object identifier cache specific to the query identifier.

4. The method of claim 2, further comprising, in response to determining that an object identifier cache specific to the query identifier does not exist:
querying one of the data sources using the filter criteria for object identifiers for objects corresponding to the filter criteria;
receiving, from the data source, the object identifiers for the objects corresponding to the filter criteria; and
caching the object identifiers in a new object identifier cache, the new object identifier cache being specific to the filter criteria.

5. The method of claim 2, wherein the server comprises a plurality of object identifier caches each indexed by a different query identifier, wherein said determining whether an object identifier cache specific to the query identifier already exists comprises:
calculating a query identifier for the query based on the query; and
determining whether any of the existing object identifier caches is indexed by a query identifier specific to the query identifier for the query.

6. The method of claim 5, further comprising:
receiving information on a modification to one of the one or more data sources;
determining one or more of the object identifier caches affected by the modification; and
invalidating the one or more affected object identifier caches.

7. The method of claim 1, wherein the server comprises a different set of object identifier caches for each respective one of a plurality of data sources, the method further comprising:
breaking down the query into a plurality of different sub-criteria of the filter criteria, wherein each different sub-criteria corresponds to a different one of the plurality of data sources;
wherein said obtaining object identifiers for data objects satisfying the query comprises:
for each different sub-criteria:
determining an object identifier cache specific to a sub-criteria identifier for the sub-criteria from the set of object identifier caches for the data source corresponding to the sub-criteria;
obtaining object identifiers from the determined object identifier cache; and
intersecting the obtained object identifiers for each sub-criteria.

8. The method of claim 7, wherein one of the sub-criteria includes a sort criteria, the method further comprising:
wherein the object identifiers in the object identifier cache matching the sub-criteria identifier including the sort criteria are ordered according to the sort criteria; and
wherein said intersecting the obtained object identifiers for each sub-criteria comprises ordering a result of said intersecting according to the order of identifier cache matching the sub-criteria including the sort criteria.

9. The method of claim 8, wherein each object identifier of the result of said intersecting is ordered by a result identifier in the order:
receiving a request from the client for a new page of results for the query;
determining a range of result identifiers for the requested new page;
obtaining the object identifiers from the result of said intersecting for the determined range; and
using the obtained object identifiers to retrieve data objects from the data sources for the requested new page.

10. The method of claim 1, further comprising:
querying the one or more data sources using the filter criteria to retrieve data objects satisfying said query, wherein said querying using the filter criteria is performed concurrently with said obtaining object identifiers and said retrieving data objects from the one or more data sources using lookup based on object identifiers; and
returning an initial result set to the client using data objects from either said querying using the filter criteria or from said retrieving using lookup based on object identifiers, depending on which obtains the initial result set sooner.

11. A system, comprising:
a processor; and
a memory coupled to the processor storing a program of instructions that when executed by the processor perform:
receiving a query from a client specifying a filter criteria;
obtaining, by a processor, object identifiers for data objects satisfying the query from one or more object identifier caches, wherein an object identifier cache of the one or more object identifier caches is specific to the filter criteria, the object identifier cache having object identifiers corresponding to querying using only the filter criteria;
retrieving data objects from one or more data sources using lookup based on object identifiers obtained from the one or more object identifier caches; and
returning the retrieved data objects to the client in response to the query.

12. The system of claim 11, wherein the program instructions when executed by the processor further perform, in response to said receiving the query, determining whether an object identifier cache specific to a query identifier for the query already exists.

13. The system of claim 12, wherein the program instructions when executed by the processor further perform, in response to determining that an object identifier cache specific to the query identifier does not exist:
querying one of the data sources using the filter criteria for object identifiers for objects corresponding to the filter criteria;
receiving, from the data source, the object identifiers for the objects corresponding to the filter criteria; and
caching the object identifiers in a new object identifier cache the new object identifier cache being specific to the filter criteria.

14. The system of claim 12, wherein the program instructions when executed by the processor maintain a plurality of object identifier caches each indexed by a different query identifier, wherein said determining whether an object identifier cache specific to the query identifier already exists comprises:
calculating a query identifier for the query based on the query; and
determining whether any of the existing object identifier caches is indexed by a query identifier specific to the query identifier for the query.

15. The system of claim 11, wherein the program instructions when executed by the processor further perform:
maintaining a different set of object identifier caches for each respective one of a plurality of data sources;
breaking down the query into a plurality of different sub-criteria of the filter criteria, wherein each different sub-criteria corresponds to a different one of the plurality of data sources;
wherein said obtaining object identifiers for data objects satisfying the query comprises:
for each different sub-criteria:
determining an object identifier cache specific to a sub-criteria identifier for the sub-criteria from the set of object identifier caches for the data source corresponding to the sub-criteria;
obtaining object identifiers from the determined an object identifier cache; and
intersecting the obtained object identifiers for each sub-criteria.

16. A non-transitory computer readable storage medium storing computer-executable program instructions that when executed by a computer perform:
receiving a query from a client specifying a filter criteria;
obtaining, by a processor, object identifiers for data objects satisfying the query from one or more object identifier caches, wherein an object identifier cache of the one or more object identifier caches is specific to the filter criteria, the first object identifier cache comprising object identifiers corresponding to querying using only the filter criteria;
retrieving data objects from one or more data sources using lookup based on object identifiers obtained from the one or more object identifier caches; and
returning the retrieved data objects to the client in response to the query.

17. The non-transitory computer readable storage medium of claim 16, wherein the program instructions when executed by a computer further perform, in response to said receiving the query, determining whether an object identifier cache specific to a query identifier for the query already exists.

18. The non-transitory computer readable storage medium of claim 17, wherein the program instructions when executed by a computer further perform, in response to determining that an object identifier cache specific to the query identifier does not exist:
querying one of the data sources using the filter criteria for object identifiers for objects corresponding to the filter criteria;
receiving, from the data source, the object identifiers for the objects corresponding to the filter criteria; and
caching the object identifiers in a new object identifier cache the new object identifier cache being specific to the filter criteria.

19. The non-transitory computer readable storage medium of claim 17, wherein the program instructions when executed by a computer maintain a plurality of object identifier caches each indexed by a different query identifier, wherein said determining comprises:
calculating a query identifier for the query based on the query; and
determining whether any of the existing object identifier caches is indexed by a query identifier specific to the query identifier for the query.

20. The non-transitory computer readable storage medium of claim 16, wherein the program instructions when executed by a computer further perform:
maintaining a different set of object identifier caches for each respective one of a plurality of data sources;
breaking down the query into a plurality of different sub-criteria of the filter criteria, wherein each different sub-criteria corresponds to a different one of the plurality of data sources;
wherein said obtaining object identifiers for data objects satisfying the query comprises:
for each different sub-criteria:
determining an object identifier cache specific to a sub-criteria identifier for the sub-criteria from the set of object identifier caches for the data source corresponding to the sub-criteria;
obtaining object identifiers from the determined an object identifier cache; and
intersecting the obtained object identifiers for each sub-criteria.

21. The method of claim 1, wherein obtaining object identifiers for data objects satisfying the query further comprises:
identifying different sub-criteria of the filter criteria;
for each different sub-criteria:
determining a respective object identifier cache specific to the respective sub-criteria; and
obtaining object identifiers from the respective object identifier cache.

22. The method of claim 21 further comprising for each different sub-criteria, intersecting the obtained object identifiers to obtain the object identifiers for data objects satisfying the query.
